(19) United States
(12) Patent Application Publication
(10) Pub. No.: US 2009/0125390 A1
(43) Pub. Date: May 14, 2009

(54) Establishment of Payment Accounts Prior to Installation or Activation of An Institutional Phone System

(76) Inventors: James P. Rokosky, Altoona, PA (US); John R. McQuade, Altoona, PA (US)

Correspondence Address: WILEY REIN LLP, 1776 K. STREET N.W., WASHINGTON, DC, 20006, US

(21) Appl. No.: 11/939,853

(22) Filed: Nov. 14, 2007

(51) Int. Cl. G06Q 40/00; G06Q 30/00

(52) U.S. Cl. 705/14; 705/35

(57) ABSTRACT

A method of establishing inmate telephone system payment accounts generally includes: identifying an institution in which a new inmate telephone system will be activated; notifying potential customers regarding the activation of the new inmate telephone system prior to installation and/or activation of the new inmate telephone system; and establishing a payment account for at least one customer prior to activation and/or installation of the new inmate telephone system. Notification may be through mail, signage, business cards, flyers, pre-recorded messages, and the like, and preferably occurs sufficiently in advance of installation and/or activation of the new inmate telephone system to permit customers to establish payment accounts such that calls may be placed to the customers almost immediately after activation of the new inmate telephone system. Accounts may be created and funds may be deposited over the Internet or over the phone (either through IVR or live CSRs).

### BACKGROUND OF THE INVENTION

a. Field of the Invention

The instant invention relates generally to telecommunication services that are provided through an institutional phone system, such as the phone system in a correctional institution. In particular, the instant invention relates to the establishment of payment accounts and the collection of money from customers before an institutional phone system is installed and/or operational.

b. Background Art

In the correctional industry, inmate phone calls are often controlled through sophisticated call processing equipment. The call processing equipment controls various aspects of the use of the telephone in order to meet a variety of competing concerns including security, accessibility, and revenue generation. One objective of an inmate telephone system is to maximize the security of the system and to also maximize the revenue produced by the system while providing the inmate with accessibility to reasonable telecommunication services as authorized by the institution.

Inmate telephone companies often install an inmate phone system for a correctional institution as a turnkey service. The vendor often installs the telephones and, in some facilities, the entire infrastructure to connect the phones (wire, conduit, etc.) to the call processing equipment. The call processing equipment may be installed on premises at the facility, at a remote call processing center, or a combination of both. Those familiar with inmate telephone systems will appreciate that expensive telephony hardware to support the calling platform must be purchased, installed, and maintained by the inmate phone company, such that installation of an institutional phone system represents a very large capital expense to an inmate telephone company. Typically, the inmate phone company pays the correctional facility a commission on revenue earned by the phone system, leaving the balance of the revenue to cover the operating costs and upfront capital expense of the inmate telephone system.

A common problem associated with operating an inmate phone system is the loss of revenue and profits due to customers' failure to pay their phone bills, the inability of the inmate telephone provider to bill the owner of the phone number for collect charges, and/or the lack of legislation requiring the local exchange carrier to collect phone charges for third parties such as inmate telephone providers. This problem is often referred to as “bad debt.” In order to control bad debt, most inmate phone companies check the credit worthiness of the phone number being called by an inmate prior to connecting a collect call to that number, often referred to as “validation” of the number being called. Often, the inmate telephone company will limit the number of collect calls to a phone number that fails validation until a suitable payment account, for example a pre-paid account, is established for the phone number. Alternatively, the inmate telephone company may block collect calls to the phone number altogether until the payment account is established. Once a payment account is established, the inmate telephone company is subject to considerably lower bad debt risk attributable to calls made to the telephone number(s) associated with the payment account.

### BRIEF SUMMARY OF THE INVENTION

When an inmate phone system is first installed by a new inmate telephone company, it is possible that many phone numbers inmates may try to call will be blocked or otherwise limited for a period of time while the owners of the phone numbers set up suitable payment accounts. This results in a large number of inmate phone call attempts being blocked during the initial period of operation of a new inmate telephone system. During this time, the correctional facility faces the possibility of inmate frustration and unrest due to the inmates' inability to complete phone calls. To avoid inmate unrest, it is desirable to provide a system that allows the inmates to complete collect calls shortly after a new inmate telephone system is installed, while also mitigating bad debt risk.

The family and friends of inmates are also affected by the installation of a new inmate telephone system. For example, if the friends and family of an inmate are not aware of changes to the inmate phone system that result in blocked calls to their phone numbers, they may not know why they are not receiving calls from the inmate. Consequently, they may call and complain to the previous inmate telephone provider or the correction facility. This situation creates a nuisance for the staff at the correctional facility, an inconvenience for the friends and family of the inmates, and lower revenues during the first few weeks after installation. Further, where the family and friends of the inmate have discretionary spending constraints, they may be unable to immediately establish a suitable payment account with the new inmate telephone company while they still have funds held in a payment account with the previous inmate telephone company. Accordingly, it is also desirable to provide a system that notifies parties called by inmates of the upcoming change to a new inmate telephone provider sufficiently far in advance to permit the parties called to establish a payment account with the new inmate telephone provider before the change occurs.

Once a new inmate telephone system is installed, it may take several months for revenue to return to the levels generated by the previous telephone system. During this period of time, the inmate telephone company generates little or no profit after operating costs and capital expenses. Moreover, the lower revenue causes the correctional facility to receive less commission, potentially leading to customer dissatisfaction and budgeting issues. The reduction in inmate phone system revenue after a new installation may be attributable to limiting the number of calls to a phone number, the customer not being aware of changes to the inmate phone system, and the time it takes for a customer open an account with the inmate phone company. It is therefore desirable to provide a system that permits the correctional institution and the inmate telephone provider to begin earning revenues shortly after installation and activation of a new inmate telephone system.

Disclosed herein is a method of establishing inmate telephone system payment accounts. The method generally includes the steps of: identifying an institution in which a new inmate telephone system will be activated; notifying potential customers regarding the activation of the new inmate telephone system prior to activation of the new inmate telephone system; and establishing a payment account for at least one customer prior to activation of the new inmate telephone system. Either or both of the notifying step and the establishing step may optionally occur prior to installation of the new inmate telephone system.

In some embodiments of the invention, the notifying step includes providing notification media to the institution and distributing the notification media to inmates within the institution, such that the inmates can notify customers regarding the activation of the new inmate telephone system. The notification media may be one or more of signage, brochures, business cards, flyers, mailers, and any combinations thereof. Alternatively, the notifying step may include playing a pre-recorded message for callers to the institution or for recipients of calls from the institution.

Payment accounts may be established through a web payment system, which may be accessible via an Internet-connected computer or a dedicated kiosk (e.g., a kiosk set up specifically for the purpose of creating payment accounts). Payment accounts may also be established through an interactive voice response system or via a conversation between a customer and a customer service representative. Of course, once a payment account is established, any one or more of the same methods may be used to add value to the account. Once one or more payment accounts are created, they may be transferred to the new inmate telephone system prior to activation of the new inmate telephone system, such that calls can be placed from the new inmate telephone system almost immediately after the new inmate telephone system has been activated.

An advantage of the present invention is that it permits the establishment of payment accounts prior to the installation and/or activation of a new inmate telephone system, thereby increasing the ability of inmates to place collect calls shortly after the installation and/or activation of a new inmate telephone system while still minimizing bad debt risk to the inmate telephone provider.

The present invention also advantageously allows an inmate telephone company to increase revenues quickly after the installation and activation of a new inmate telephone system.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a diagram of the actors involved in entering a new correctional facility in the inmate telephone company's billing database.

FIG. 2 is a diagram of the actors and systems involved in the automated payment services offered by the inmate telephony company.

FIG. 3 is a diagram of the actors and systems involved in payments received by customer service representatives.

FIG. 4 is an abbreviated diagram of the systems involved in the transfer of data between the inmate telephone company and a correctional facility

### DETAILED DESCRIPTION OF THE INVENTION

The present invention provides a method and system for establishing payment accounts prior to installation and/or activation of an institutional telephone system. The term “institutional telephone system” (or “institutional phone system”) as used herein refers to a telephone system installed in an environment wherein it is desirable to control or regulate telephone usage, including, without limitation, correctional facilities, military installations, hospitals, schools, business offices, and government offices. Though the invention will be described in connection with the corrections industry, and in particular in connection with an inmate telephone system, it should be understood that the invention is not so limited. One of ordinary skill in the art will appreciate that the principles disclosed herein may be employed to good advantage in any telephone system where it is desirable to minimize bad debt risk associated with telephone calls.

The payment account establishment system according to the present invention may be implemented as an enhancement to an inmate telephone system, such as the ITI Offender Communication System. Of course, the payment account establishment system disclosed herein may also be implemented in connection with other inmate telephone systems, including, but not limited to, Global Tel*Link's LazerPhone system, Securus Technologies' Secure Call Platform, Pay-Tel Communications, Inc.'s inmate telephone system, and PCS Corporation's Inmate Communications Systems. One of ordinary skill in the art will generally appreciate the functions and capabilities of an inmate telephone system. Thus, inmate telephone systems, such as those listed above, are described herein only to the extent necessary to understand the present invention.

The present invention allows a customer to open a new payment account with the new inmate telephone provider and make payments to the account prior to the installation and/or activation of the new inmate telephone system. The invention provides the customer with multiple methods for opening accounts and making payments. For purposes of this disclosure, the term “customer” refers to the recipient of a call placed using the inmate telephone system. Thus, a potential customer is a likely recipient of calls placed using the inmate telephone system.

Notifying customers that they can establish their accounts with the new inmate telephone provider is facilitated by distributing information to the correctional facility for distribution to the inmates in advance of the installation and/or activation of the new inmate telephone system. The inmates can then in turn notify the parties that they call (that is, the customers) about the upcoming change in inmate telephone providers.

Accordingly, in the time period leading up to the installation and/or activation of the new phone system, the inmate telephone company provides information to the facility's inmates about the new inmate telephone system. This information, regarding the set-up of payment accounts and the making of payments to the new inmate telephony company, may be provided to the correctional facility in the form of signage, brochures, business cards, flyers, mailers, or other media for distribution to inmates. The early distribution of this information to the inmates allows the inmates to communicate this information to their friends and families well before the new inmate telephone system is installed and/or activated. The friends and families of the inmates can then budget for a deposit on a payment account with the new inmate phone company, and can also make arrangements to close their accounts with the old inmate telephone company as the installation and/or activation date of the new inmate telephone system draws near. It is also contemplated that notification may be provided through a pre-recorded message that is played for recipients of calls from the institution and/or callers to the institution.

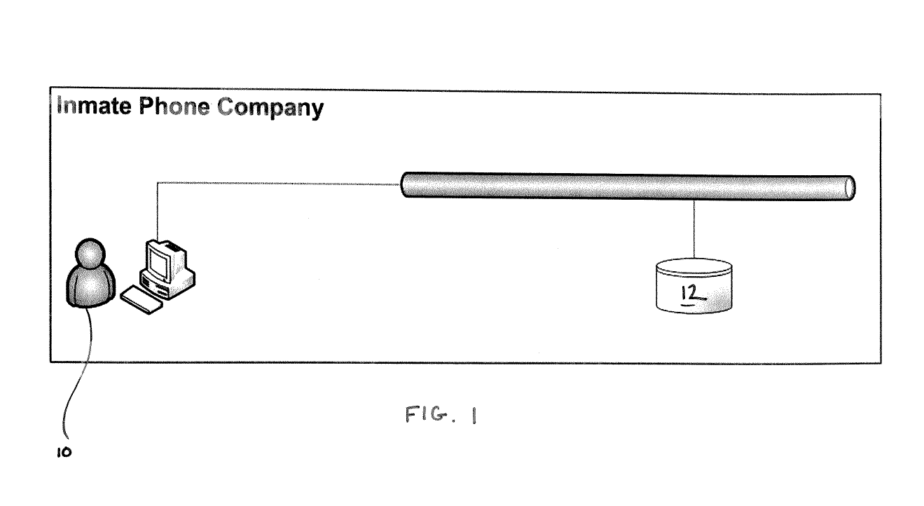

A description of the methods of making payments and opening accounts will be described with reference to FIGS. 1 through 3. As shown in FIG. 1, once a contract is signed to provide inmate telephone service to a correctional facility, an employee 10 of the inmate telephone company creates an entry for the correctional facility in the inmate telephone company's billing system database 12. The new facility is configured to allow payments to be recorded in the inmate telephone company's billing system. Accordingly, the facility becomes visible to the call center operators and various automated payment processing systems as a destination facility for customer payments. The billing system database is configured to open accounts and accept payments for the new correctional facility, such that customers can establish and make deposits to payment accounts for calls from the correctional facility, as described in further detail below.

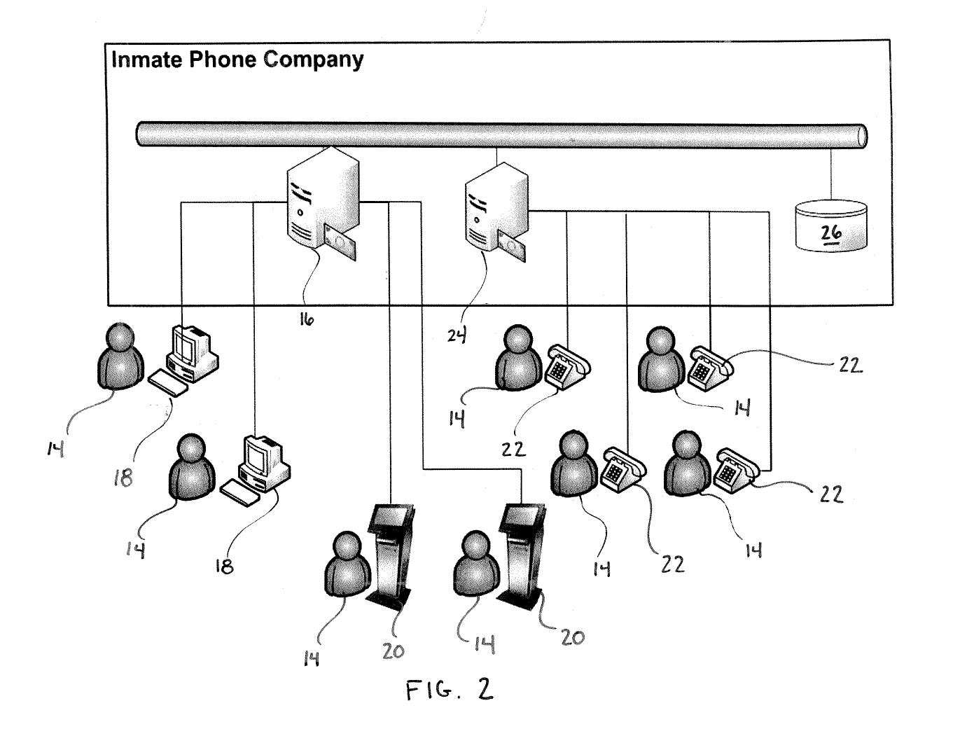

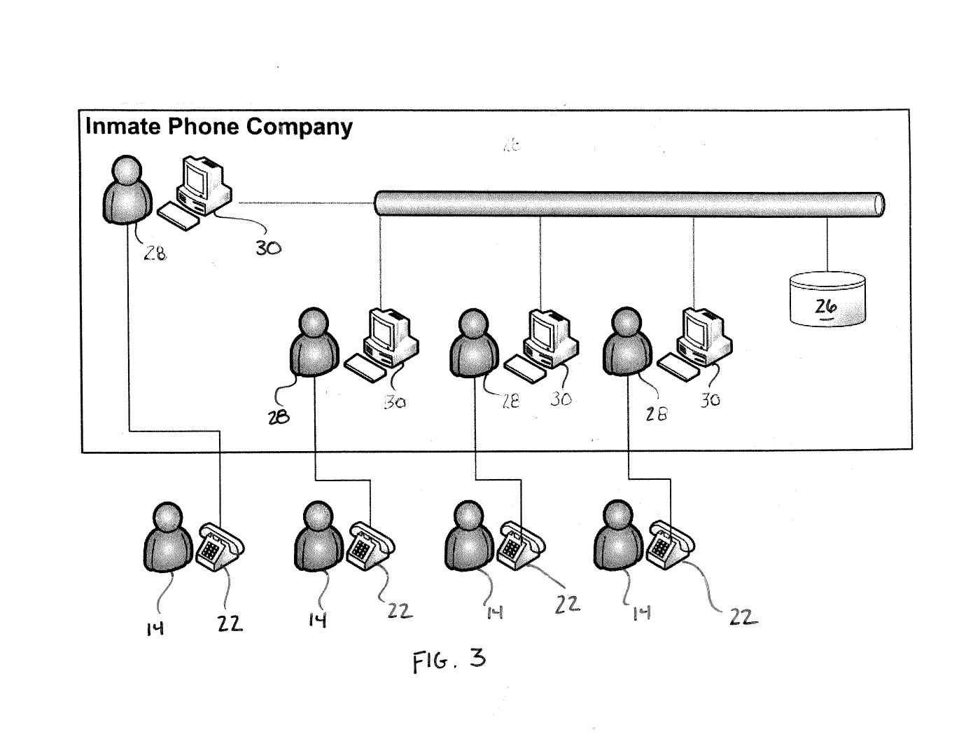

FIGS. 2 and 3 illustrate various methods by which customers 14 can establish and make deposits to accounts with the new inmate telephone provider. FIG. 2 illustrates automated methods allowing customers to open accounts and make payments before new installations and/or activations. For example, a web payment server 16 can accept payments from customers accessing the Internet through their personal computers 18 or via kiosks 20. Alternatively, customers may establish accounts and make deposits via telephones 22 connected to an interactive voice response (IVR) server 24. Both web payment server 16 and IVR server 24 are coupled to billing system database 26 to store accounts and payments. Additional automated methods of establishing accounts and making deposits will be readily appreciated by those of ordinary skill in the art. Such methods are regarded as within the spirit and scope of the present invention, and are omitted here for the sake of brevity.

As shown in FIG. 3, the inmate telephone company's call center may also be equipped for customers 14 to call a live customer service representative (CSR) 28, rather than IVR server 24, to open an account or make a deposit. CSRs 28 can open accounts and post payments to the billing system database 26 through computers 30.

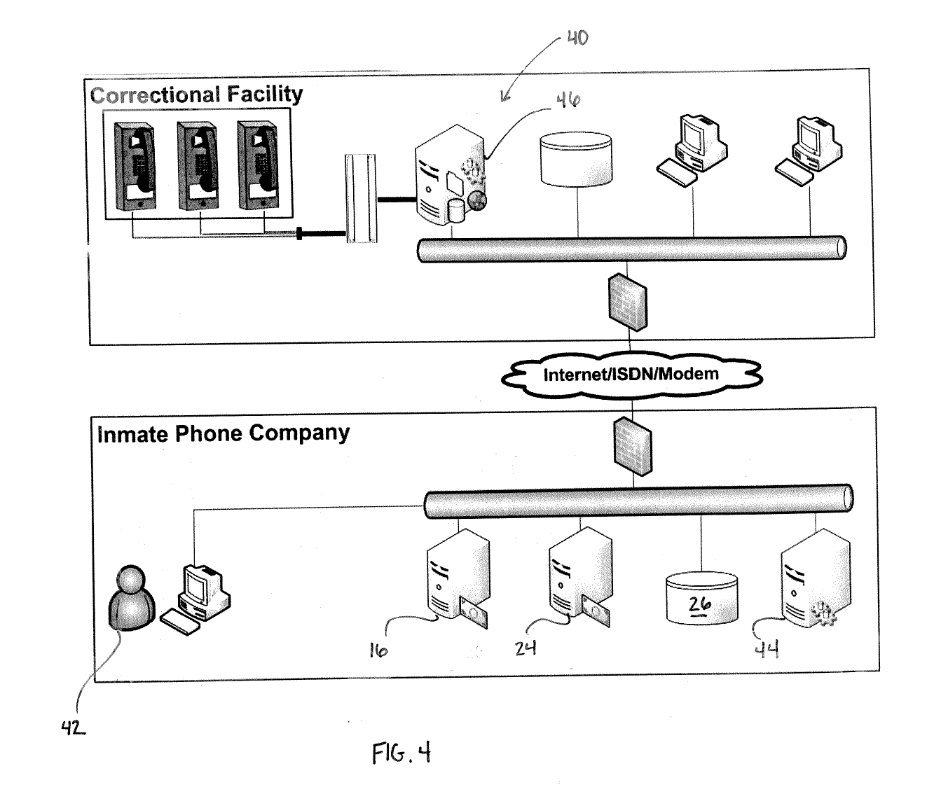

All opened accounts and payments that are made prior to installation and/or activation of the new inmate telephone system are saved in the billing system database 26. Once the phone system 40 (FIG. 4) is installed and operational in the correctional facility, an employee 42 will enable the data transfer for that facility. A data transfer server 44 sends and receives billing information to and from the correctional facility across a network, such as the Internet. Of course, other connections between the inmate telephone company and the correctional facility are also contemplate (e.g., ISDN, modem). An initial data transfer can be used to upload all open accounts and payments to the inmate phone system servers 46 upon (or immediately prior to) activation of the inmate phone system 40. Such an initial load advantageously make funds on account available for immediate use when the new inmate telephone system comes into service.

By opening accounts and receiving payments prior to the installation of an inmate phone system, an increase in revenues is realized in the period immediately following the installation and activation of a new inmate telephone system. Additionally, the likelihood of inmate unrest is reduced and customer and client satisfaction are increased.

Although several embodiments of this invention have been described above with a certain degree of particularity, those skilled in the art could make numerous alterations to the disclosed embodiments without departing from the spirit or scope of this invention. Therefore, it is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of establishing inmate telephone system payment accounts, the method comprising:
identifying an institution in which a new inmate telephone system will be activated;
notifying potential customers regarding the activation of the new inmate telephone system prior to activation of the new inmate telephone system; and
establishing a payment account for at least one customer prior to activation of the new inmate telephone system.

2. The method according to claim 1, wherein the notifying step occurs prior to installation of the new inmate telephone systems.

3. The method according to claim 1, wherein the establishing step occurs prior to installation of the new inmate telephone system.

4. The method according to claim 1, wherein the notifying step comprises:
providing notification media to the institution; and
distributing the notification media to inmates within the institution, such that the inmates can notify customers regarding the activation of the new inmate telephone system.

5. The method according to claim 4, wherein the notification media comprises one or more of signage, brochures, business cards, flyers, mailers, and any combinations thereof.

6. The method according to claim 1, wherein the notifying step comprises playing a pre-recorded message for callers to the institution.

7. The method according to claim 1, wherein the notifying step comprises playing a pre-recorded message for recipients of calls from the institution.

8. The method according to claim 1, wherein the establishing step comprises establishing the payment account through a web payment system.

9. The method according to claim 8, wherein the web payment system is accessed via an Internet-connected computer.

10. The method according to claim 8, wherein the web payment system is accessed via a dedicated kiosk.

11. The method according to claim 1, wherein the establishing step comprises establishing the payment account through an interactive voice response system.

12. The method according to claim 1, wherein the establishing step comprises establishing the payment account through a conversation between a customer and a customer service representative.

13. The method according to claim 1, further comprising transferring the payment account for the at least one customer into the new inmate telephone system prior to activation of the new inmate telephone system.
